(19) United States
(12) Patent Application Publication
(10) Pub. No.: US 2005/0126238 A1
(43) Pub. Date: Jun. 16, 2005

(54) Plant nutrient and method of making

(75) Inventor: Donald E. Gordon, Baltimore, MD (US)

Correspondence Address: ARMSTRONG, KRATZ, QUINTOS,;HANSON & BROOKS, LLP, Intellectual Property Law Offices, 502 Washington Avenue, Suite 220, Towson, MD, 21204, US

(73) Assignee: QC CORPORATION

(21) Appl. No.: 10/733,420

(22) Filed: Dec. 11, 2003

(51) Int. Cl. C05C 1/00

(52) U.S. Cl. 71/27

(57) ABSTRACT

Soil and water dispersable plant nutrients in the form of metal carboxylates (sucrates) are formed from the combination of metal oxides and saccharides. A method of preparing granular metal carboxylates (sucrates) is provided. Metal oxides, lime, clay and aqueous beet sugar extract are combined and fed through a roll press compactor with 100 tons of pressure which elevates the material temperature to approximately 170° F., driving the reaction to completion. The compacted metal carboxylates (sucrates) are milled, screened, and wax coated.

### BACKGROUND OF THE INVENTION

1. Field of the Invention

The present invention relates to plant nutrients and more particularly metallic plant nutrients reacted with a saccharide and formed into free-flowing granules.

2. Description of Related Art

It is well recognized that plant nutrients in the form of metallic salts are needed for proper plant growth. There have been numerous formulations and methods to provide the nutrients.

U.S. Pat. No. 3,353,949 to Nau discloses a granular product comprising secondary nutrients and micro-nutrients together with a binder in which the nutrients are not segregated.

In U.S. Pat. No. 3,567,460, McCoy discloses a granular plant nutrient which has a polysacchoride binder and water and which is dried after granulation.

In U.S. Pat. No. 5,487,772, McCoy discloses the formation of carboxylates of nutrients by the reaction with sugarcane molasses. The product is dried, screened and cured.

Although these patents address the need for biologically available plant nutrients, the commercial products available carry a dust warning and are subject to caking (clumping). There is a need to have an economical and efficient method to prepare a product that provides biologically available nutrients, produces minimal dust, remains free-flowing in typical applications, and has a more reasonable shelf-life than currently available commercial products.

### BRIEF SUMMARY OF THE INVENTION

It is an object of the present invention to provide a product of biologically available plant nutrients, specifically, metal carboxylates (sucrates). The present invention involves combining metal oxides with beet sugar extract, clay, and lime. During the process of compaction, a chemical reaction occurs converting the metal oxide to a metal carboxylate (sucrate). The clay is incorporated into the granule to assist in the breakdown of said granule in soils in the presence of water. This aids in the dispersion and availability of the nutrients.

It is a further object of the present invention to provide a cost effective, efficient method to prepare biologically available plant nutrients. The present invention involves using a compactor and mill combination to form granules in an efficient and cost effective manner. This also allows the product to contain a higher concentration of metal in the final product.

It is still another object of the present invention to provide biologically available plant nutrients in a product that contains minimal dust. The present invention applies a wax coating to formed granules to contain any residual dust.

It is still another object of the present invention to provide a product that remains free-flowing and does not cake or clump. The present invention incorporates an absorbent clay into the granule that is formed by compaction and coats said granule with a wax. The pressure and heat of compaction from this process yields a product less likely to cake or clump, the absorbency of the clay reduces caking or clumping, and the wax coating also inhibits caking or clumping.

It is still another object of the present invention to provide a material with a longer shelf-life than current commercial products. Reducing caking or clumping by the use of compaction, clay, and wax coating will extend the product shelf-life.

In accordance with the teachings of the present invention, there is disclosed a method of preparing a plant nutrient in the form of a granular metal carboxylate (sucrate) having the molecular formula: 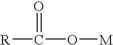
wherein R is a saccharide derived from beet sugar extract and M is a nutrient cation from a metal oxide. Finely divided particles of the plant nutrient are provided. The plant nutrient is mixed with lime and clay. A concentrated aqueous solution of beet sugar extract is provided. The aqueous solution of beet sugar extract is sprayed onto the mix of lime, clay and plant nutrient to form a mixture. The mixture is introduced into a compactor where the aqueous solution of beet sugar extract, lime, clay and plant nutrient are heated due to friction of compaction. The beet sugar extract reacts with the plant nutrient to form a saccharide (sucrate). The output from the compactor is milled to form particles and screened to a desired particle range.

In further accordance with the teachings of the present invention, there is disclosed a method of preparing a plant nutrient. A metallic oxide is mixed with lime and the mix is sprayed with a concentrated aqueous saccharide solution. The metallic oxide, lime and aqueous saccharide solution are introduced into a compactor to be heated by the friction of compaction to form a nutrient saccharide (sucrate). The compacted material is milled and screened to a desired particle range.

In still further accordance with the teachings of the present invention there is disclosed a plant nutrient comprising a metal oxide, lime, clay and a sugar (sucrate) solution. These components are compressed at elevated temperature to form the nutrient saccharide (sucrate) and milled to a desired particle range. Each particle is coated with a wax.

These and other objects of the present invention will become apparent from a reading of the following specification taken in conjunction with the enclosed drawings.

### BRIEF DESCRIPTION OF THE DRAWINGS

FIG. 1 is a block diagram showing the method of making the plant nutrient formulation.

FIG. 2 is a cross section view of a roll press type of compactor.

FIG. 3 is a cross section view of a wax coated granule of the plant nutrient.

### DESCRIPTION OF THE INVENTION

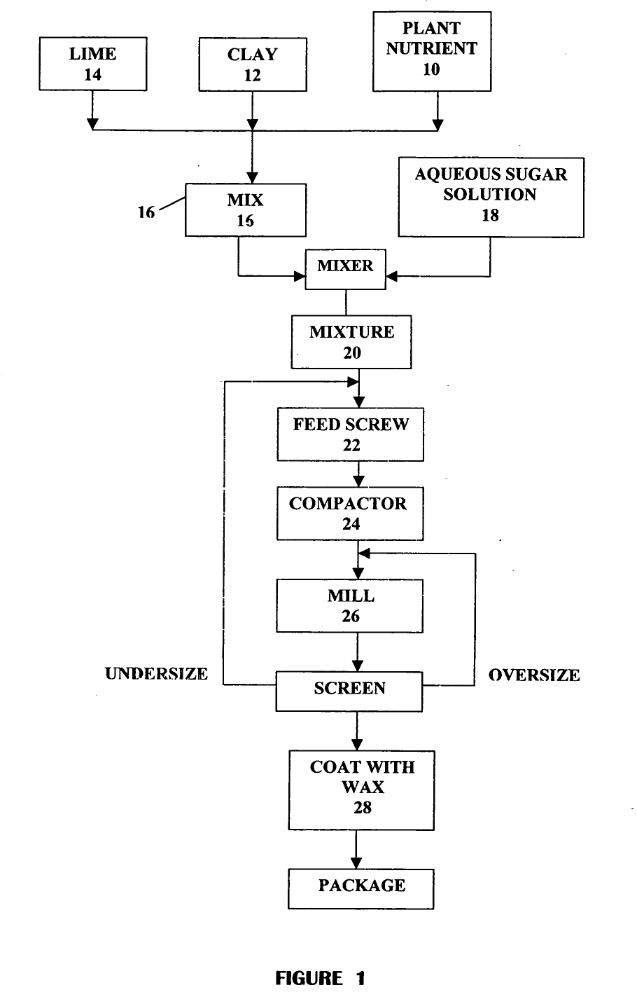

As shown in FIG. 1, the metallic plant nutrients 10, the clay 12 and lime 14 are formed in a mix 16, preferably using a paddle mixer or a ribbon blender to assure homogeneality. The plant nutrients preferably are oxides of metals including, but not limited to, iron, zinc, manganese, magnesium, and calcium and mixtures thereof. The metal oxides are preferred to be finely ground in the range of 325 mesh.

The clay 12 is naturally occurring bentonite. The particle size is >70% minus 200 mesh. It is an absorbent material that aids in the breakdown of the granulated sucrate micronutrients and acts as a dispersing agent for the nutrients allowing for more efficient plant availability in the presence of moisture contained in soils. The strong absorbency of the clay also allows for a product (micronutrient sucrate) that resists caking or clumping.

The lime 14 is a calcium product from limestone. The particle size is >99% minus 325 mesh and it serves as a filler.

A concentrated aqueous solution of sugar 18 or saccharide is prepared. The sugar may be from any one or more sources but it is preferred that the sugar be a byproduct of the fermentation industries based on beets (an extract). Concentrated Separator By-Product (CSB) obtained from beet sugar molasses has been used satisfactorily. The preferred solution contains approximately 65% solids and is 17-20% sugars. This provides a solution that weighs approximately 11 pounds per gallon. The ability of this system to incorporate a solution this high in sugars and solids allows a higher concentration of nutrient in the final product than is currently commercially available.

The sugar (or saccharide) solution 18 is sprayed (preferably in a mixer) onto the homogeneous mix 16 of the plant nutrient 10, the clay 12 and the lime 14.

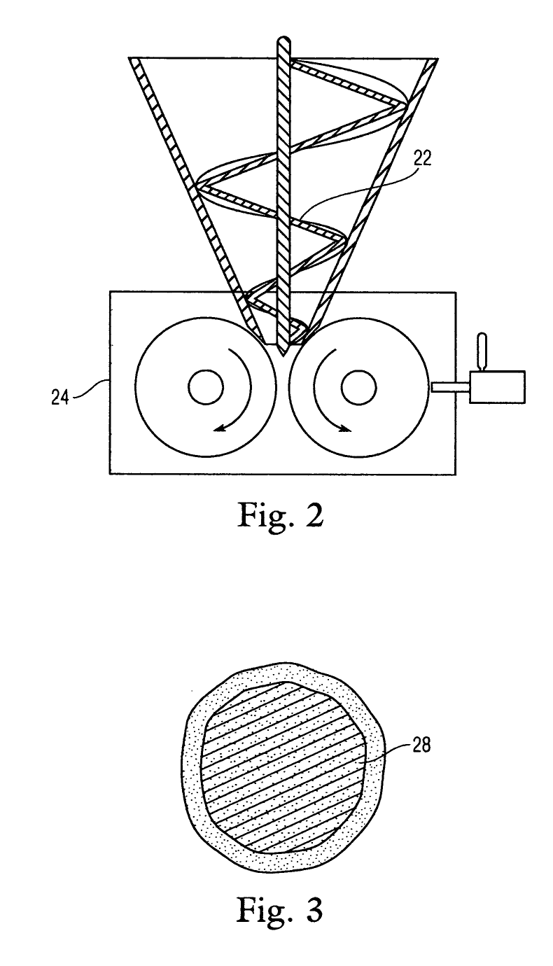

The mixture 20 is directed into a vertical deaerating feed screw 22 which feeds a compactor 24. It is preferred that the compactor be a roll press as shown in FIG. 2.

A roll press type compactor has the ability to compact large quantities of material at relatively low cost. The product is comparatively dust free. The compactor usually has two countercurrently rotating rolls and the mixture is directed between the rolls. Alternately, one roll may be fixed and the other roll is rotatable and may be moved to press against the fixed roll. The particles of the mixture 20 are deformed and compacted. In the compactor approximately 100 tons (±10%) of pressure is applied to the mixture 20. Due to the friction of forces of the compactor 24, the temperature of the mixture 20 is elevated to approximately 170° F. At this temperature, under this pressure, the plant nutrient reacts with the carboxylic acid functional groups of the sugar 18 to further form metal carboxylates (sucrates). The metal carboxylate has the chemical structure 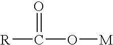
wherein R is a saccharide derived from a beet sugar extract (preferably CSB) and M is a nutrient cation from a metal oxide. Due to this pressure and heat of compaction, a product is formed that will not set-up or cake as opposed to prior art.

The product output from the compactor 24 is introduced to a mill 26 where the product is milled to particles of an approximate desired range of minus 5 plus 20 mesh (4 mm-0.85 mm). The particles are screened to a desired range of particle size. The undersize, fine material is recycled back into the feed screw 22. The oversize, coarse material is recycled back into the mill 26.

The particles or granules of the desired range of sizes are then sprayed with a wax 28 to coat the individual particles (FIG. 3). The wax is a crude paraffin wax product that is a solid at normal working temperatures and must be heated for application. This coating further reduces dust and aides in the prevention of caking or clumping.

Typical nutrient formulations for iron, manganese, zinc and magnesium are as follows:

| Lbs./Ton of final product | Ingredient | % (by weight) |
|---|---|---|
| Iron | | |
| 1515 | Iron oxide (68% Fe) | 75 |
| 174 | Lime | 9 |
| 174 | Clay | 9 |
| 98 | Beet sugar solution | 5 |
| 39 | Wax | 2 |
| Manganese | | |
| 1503 | Manganous oxide (60% Mn) | 75 |
| 180 | Lime | 9 |
| 180 | Clay | 9 |
| 98 | Beet sugar solution | 5 |
| 39 | Wax | 2 |
| Zinc | | |
| 1253 | Zinc oxide (72% Zn) | 63 |
| 305 | Lime | 15 |
| 305 | Clay | 15 |
| 98 | Beet sugar solution | 5 |
| 39 | Wax | 2 |
| Magnesium | | |
| 1667 | Magnesium oxide (54% Mg) | 83 |
| 98 | Lime | 5 |
| 98 | Clay | 5 |
| 98 | Beet sugar solution | 5 |
| 39 | Wax | 2 |

These typical formulations are examples by way of illustration but are not limitations on the scope of the invention. The percentage of the ingredients may vary by ±10% or more from the typical formulations. The percent of metal in the metal oxide is a function of the purity of the available material. This variation must also be reflected in the percent of lime, clay and beet sugar solution. The formulation is adjusted based on the purity of the metal oxide. Thus, the present invention has a broad scope in providing for use of a wide range of purity of the metal oxide.

It is desired that a minimum of 5% by weight of the solution of beet sugar extract be present in the formulation. The amount of lime and clay are approximately equal but the ratio may vary by 10%-20%.

This process provides a relatively dust free, non-caking nutrient which is free-flowing and can be applied to plants in a uniform controlled manner. The present invention provides a procedure for preparing plant nutrients in the form of sucrates which is more economical and versatile than previously known procedures and which has higher concentrations of metal sucrates. The present invention does not require drying or curing.

Obviously, many modifications may be made without departing from the basic spirit of the present invention. Accordingly, it will be appreciated by those skilled in the art that within the scope of the appended claims, the invention may be practiced other than has been specifically described herein.

1. A method of preparing a plant nutrient in the form of a granular metal carboxylate (sucrate) having the molecular formula: 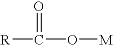
wherein R is a saccharide derived from a beet sugar extract and M is a nutrient cation from a metal oxide and comprising the steps of:
providing finely divided particles of the plant nutrient,
preparing a mix of the plant nutrient with lime and clay,
providing a concentrated aqueous solution of beet sugar extract,
spraying the aqueous solution of beet sugar extract onto the mix of lime, clay and plant nutrient to form a mixture,
introducing the mixture into a compactor where the aqueous solution of beet sugar extract, lime, clay and plant nutrient are heated due to friction of compaction and the beet sugar extract reacts with the plant nutrient,
milling the output from the compactor to particles and screening to a desired particle range.

2. The method of claim 1, wherein the plant nutrient is an oxide of iron.

3. The method of claim 1, wherein the plant nutrient is an oxide of zinc.

4. The method of claim 1, wherein the plant nutrient is an oxide of magnesium.

5. The method of claim 1, wherein the plant nutrient is an oxide of manganese.

6. The method of claim 1, wherein the plant nutrient is an oxide of calcium.

7. The method of claim 1, wherein the beet sugar extract is a byproduct of the fermentation industry.

8. The method of claim 1, wherein the plant nutrient may have a range of purity, the purity of the plant nutrient determining the relative amount of lime, clay and solution of beet sugar extract in the composition, the solution of beet sugar extract being a minimum of 5% by weight.

9. The method of claim 1, wherein the temperature of the mixture in the compactor is approximately 170° F.

10. The method of claim 1, wherein the pressure in the mixture in the compactor is approximately 100 tons.

11. The method of claim 1, wherein the compactor is a roll press.

12. The method of claim 1, wherein the mixture of lime, clay, metallic plant nutrient and solution of beet sugar extract are directed into a vertical deaerating feed screw before being introduced into the compactor.

13. The method of claim 1, further comprising the milled product being sprayed with a wax to coat the screened particles thereby assuring a free-flowing, non-caking, dust free product.

14. The method of claim 1, wherein the output of the screening are particles in the range of minus 5 plus 20 mesh (4 mm to 0.85 mm).

15. A plant nutrient prepared by the method of claim 1.

16. A method of preparing a plant nutrient comprising the steps of:
mixing a metallic oxide with lime and spraying the mix with a concentrated aqueous saccharide solution,
introducing the metallic oxide, lime and concentrated aqueous saccharide solution into a compactor to be heated by the friction of compaction,
milling the compacted material and screening to a desired particle range.

17. The method of claim 16, wherein clay is mixed with the metallic oxide and the lime prior to spraying with the concentrated aqueous saccharide solution.

18. The method of claim 16, further comprising the milled and screened product being sprayed with a wax.

19. The plant nutrient prepared by the method of claim 16.

20. A plant nutrient comprising metal oxide, lime, clay and a sugar solution compressed at elevated temperature and milled to form particles having a desired particle range, each particle being coated with a wax.

21. The plant nutrient of claim 20, wherein the metal oxide is selected from the group consisting of iron, zinc, manganese, magnesium, calcium and mixtures thereof.

22. The plant nutrient of claim 20, wherein the sugar solution is present at a minimum of 5% by weight.

23. The plant nutrient of claim 20, wherein the sugar solution is a byproduct of fermentation of beet sugar.

24. The plant nutrient of claim 20, wherein the sugar solution is 17-20% sugar.

25. The plant nutrient of claim 20, wherein the sugar solution has a minimum dry matter content of 65%.
